(19) United States
(12) Patent Application Publication
(10) Pub. No.: US 2002/0149611 A1
(43) Pub. Date: Oct. 17, 2002

(54) Emoticons

(76) Inventor: Julian S. May, Klosters (CH)

Correspondence Address: HARNESS, DICKEY & PIERCE, P.L.C., P.O. BOX 828, BLOOMFIELD HILLS, MI, 48303, US

(21) Appl. No.: 09/832,665

(22) Filed: Apr. 11, 2001

(51) Int. Cl. G06F 3/00

(52) U.S. Cl. 345/706

(57) ABSTRACT

An apparatus and method are provided for receiving input data (406) from a user based on a user's emotional response to a property (904, 908), including a plurality of network-connected user terminals (101, 102, 103), wherein each of said terminals includes memory means (302) and processing means (301, 304). Said memory means (302) is configured to receive (503) instructions (404) from one of said network-connected terminals (103) and said instructions (404) configure said processing means (301, 304) to perform the steps of displaying (504) a modifiable graphical control (906, 907), displaying (504) an adjustable and emotionally representative character, adjusting (506) a representation (905, 909) of said character in response to the modification (505) of said graphical control (906, 907) and receiving (508) input data (406) in response to said modification (505) of said graphical control (906, 907).

### BACKGROUND OF THE INVENTION

1. Field of the Invention

The present invention relates to a method of receiving input data from a user, based on a user's emotional response to a property.

2. Description of the Related Art

Numerous methods exist to receive input data from users within network environments. Users browsing network resources by means of network-connected computer terminals, such as Internet sites for instance, are frequently asked to provide feedback about particular issues or properties featured within said resources, or sites, by means of computer-generated surveys graphically displayed within their Internet browser.

Traditionally, said surveys take the form of one or a plurality of questions, the answers to which require said users to provide either quantifiable input data, such as how many times they browse the Internet within a certain period of time, or qualifiable and therefore non-quantifiable data, such as what is their opinion about the appearance of a site, in which case an emotion-driven answer is requested. In order to provide said answers, users interact with the graphical interface of a computer-generated survey by means of their terminal input means, such as a keyboard or a mouse or a combination thereof, and input said answers within said interface.

However, computer-generated survey interfaces according to the prior art remain mostly based upon non-electronic criteria in terms of design, functionality and ease-of-use, and thus a question requiring a qualifiable, i.e. non-quantifiable, answer typically features numerous selectable answers displayed as plain text, as would be featured in a survey carried out by means of a paper questionnaire.

Within the realm of networked environments such as the Internet, wherein the inherent wealth of information requires users to maintain a fairly limited attention span in order to carry out effective information gathering within acceptable time constraints, such interfaces according to the prior art are known to generate very little input data for, say, the commissioners of a survey. Indeed, said interfaces are not conductive of the functionality and ease-of-use required to generate input data from a user based on said user's emotional response as their interface is not emotionally-representative, and the ability of said surveys to retain a user's attention is further limited owing to the text-based nature of the available answers, wherein little available user interactivity is apparent.

### BRIEF SUMMARY OF THE INVENTION

According to a first aspect of the present invention there is provided an apparatus for receiving input data from a user based on a user's emotional response to a property, including a plurality of network-connected user terminals, wherein each of said terminals includes memory means and processing means. Said memory means is configured to receive instructions from one of said network-connected terminals and said instructions configure said processing means to perform the steps of displaying a modifiable graphical control, displaying an adjustable and emotionally representative character, adjusting a representation of said character in response to the modification of said graphical control and receiving input data in response to said modification of said graphical control.

According to a second aspect of the present invention, there is provided a method of receiving input data from a user based on a user's emotional response to a property, comprising the steps of displaying a modifiable graphical control, displaying an adjustable and emotionally representative character, adjusting a representation of said character in response to the modification of said graphical control and receiving input data in response to said modification of said graphical control.

### BRIEF DESCRIPTION OF THE DRAWINGS

FIG. 1 illustrates a network environment, including user terminals;

FIG. 2 shows a network-connected terminal of the type illustrated in FIG. 1;

FIG. 3 details hardware components of a user terminal of the type illustrated in FIGS. 1 and 2, including a memory;

FIG. 4 details the contents of the memory shown in FIG. 3, including an interface application;

FIG. 5 summarises actions performed at a network-connected terminal according to the invention;

FIG. 6 summarises actions performed at said network-connected terminal in order to load from a remote server and locally execute the program instructions;

FIG. 7A illustrates machine-readable instructions shown in FIGS. 4 in Java according to a preferred embodiment of the present invention;

FIG. 7B illustrates machine-readable instructions shown in FIGS. 4 in Dynamic Hyper Text Mark-up Language (DHTML) according to an alternative preferred embodiment of the present invention;

FIG. 8 details the contents of an interface table and a response table in the memory shown in FIG. 3;

FIG. 9 provides a graphical representation of the Graphical User Interface (GUI) of the interface application shown in FIG. 8, including adjustable and emotionally representative characters and modifiable graphical controls;

FIG. 10 summarises actions performed by the interface application in order to modify the graphical control shown in FIG. 9;

FIG. 11 summarises actions performed by the interface application in order to adjust the emotionally representative character in FIG. 9;

FIG. 12 provides a graphical representation of the GUI shown in FIG. 9, including one of said emotionally representative characters and its respective graphical control modified according to the actions shown in FIGS. 10 and 11;

FIG. 13 summarises actions performed by the interface application in order to update the response table shown in FIG. 8;

FIG. 14 provides a graphical representation of the GUI shown in FIG. 12 at two different network-connected user terminals, including emotionally representative characters and graphical controls modified according to the actions shown in FIG. 13;

FIG. 15 summarises actions performed by the interface application subsequently to the modifications shown in FIG. 14;

FIG. 16 details the contents of a database receiving response tables from network-connected user terminals at a network-connected server;

### BEST MODE FOR CARRYING OUT THE INVENTION

The invention will now be described by way of example only with reference to the previously identified drawings.

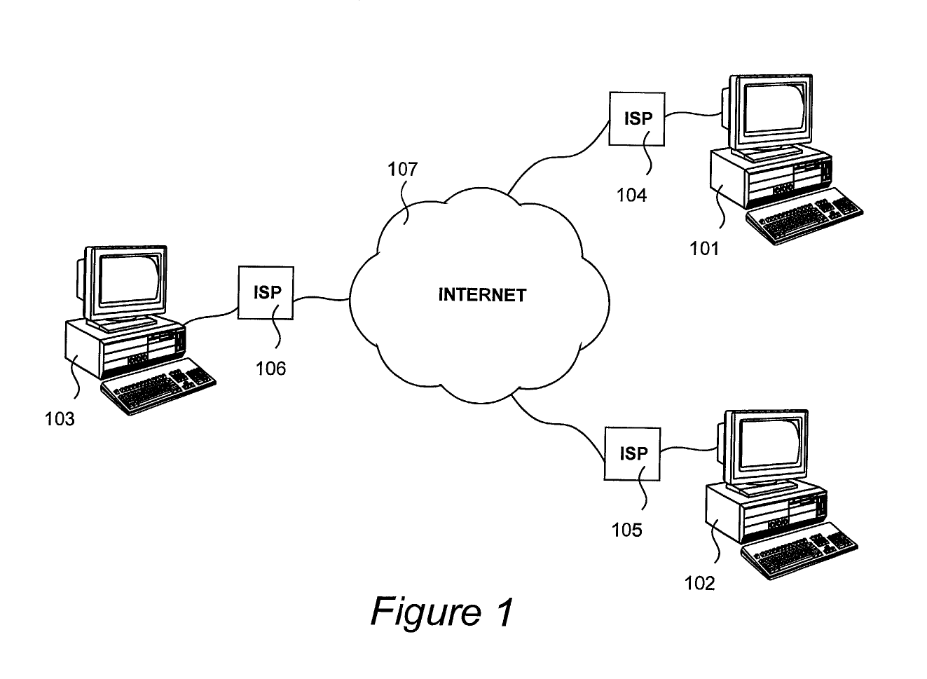

FIG. 1

An environment for connecting multiple users from whom input data will be received is illustrated in FIG. 1.

User terminals 101, 102 and server 103 are connected via their respective Internet Service Providers (ISP) 104, 105, and 106 to the Internet 107. The ISPs 104 to 106, in combination with user terminals 101, 102 and server 103, provide each individual user with a unique Internet Protocol (IP) address, an e-mail account and other optional internet facilities such as are commonly provided to a user with an ISP account. Provided that appropriate data transfer applications, protocols and permissions have been set up, there is provided the scope for any which one of user terminals 101 and 102 to access data stored on server 103.

In the example, user terminals 101 and 102 are connected to the Internet via ISP 104 and 105 respectively. Upon performing requests to access data stored on server 103, said requests from user terminals 101 and 102 respectively transit via ISP 104 and 105 to ISP 106, which in turns transmits said requests to server 103. Provided operators of user terminals 101 and 102 are allowed to access data stored on server 103, server 103 will grant user terminals 101 and 102 access to its stored data.

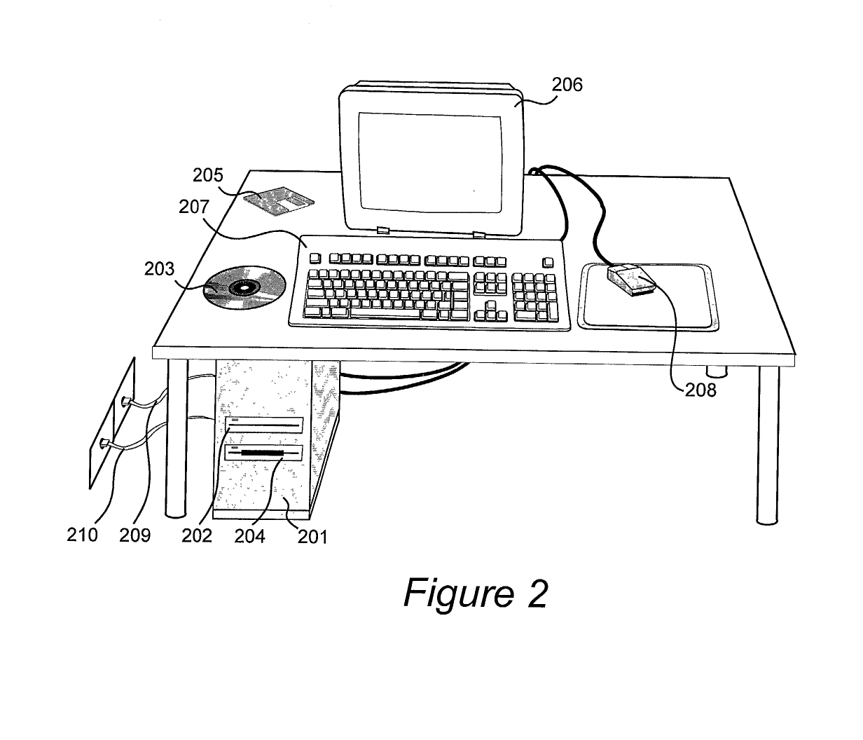

FIG. 2

A user terminal, such as user terminal 101, is shown in FIG. 2.

User terminal 101 includes a programmable computer 201 having a drive 202 for receiving CD-ROMs 203 and a drive 204 for receiving high-capacity magnetic disks, such as zip disks 205. Output data from computer 201 is displayed on a visual display unit 206 and manual input is received via a keyboard 207 and a mouse 208. Data may also be transmitted and received by computer 201 over a Local Area Network (LAN) 209, or the Internet 107 by means of modem connection 210. Thus computer 201 may receive program instructions via a CD-ROM 203, LAN 209 or the Internet 107 and input data may be written to a zip disk 205 by means of drive 204.

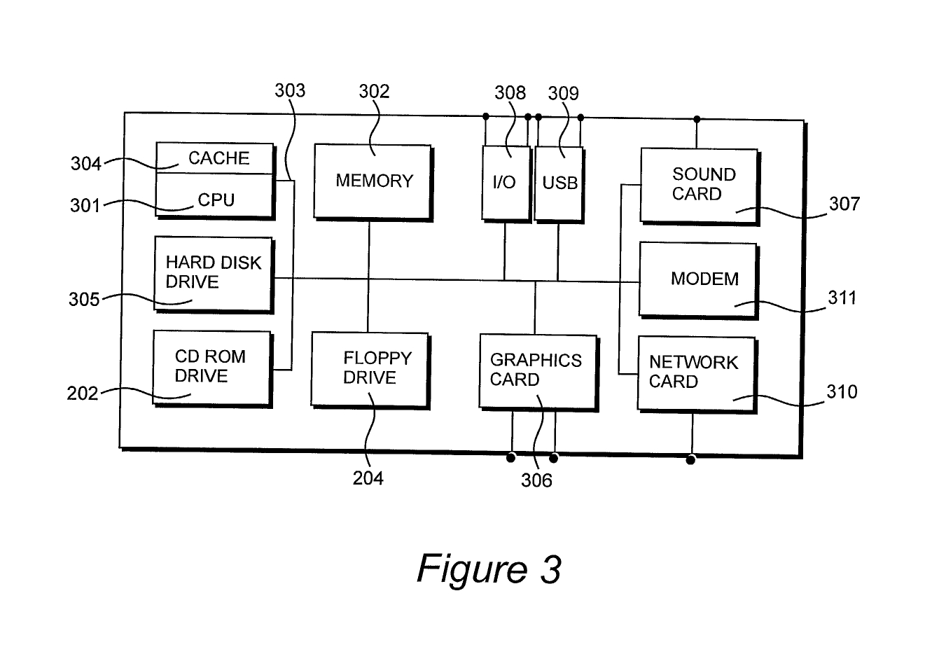

FIG. 3

The hardware components of computer system 201 are detailed in FIG. 3.

The system includes a central processing unit (CPU) 301 operating under instructions received from random access memory 302 via a system bus 303. The CPU 301 fetches and executes instructions and manipulates data and the most frequently accessed instructions and data are stored in a high speed cache memory 304. The system bus 303 provides CPU 301 with connectivity with a larger main memory 302, which requires significantly more time to access than the cache 304.

Memory 302 comprises one hundred and twenty-eight megabytes of randomly accessible memory and executable programs which, along with data, are received via said bus 303 from a hard disk drive 305, or LAN 209 or the Internet 107. The hard disc drive (HDD) 305 provides non-volatile bulk storage of instructions and data. A graphics card 306 receives graphics data from the CPU 301, along with graphics instructions. Preferably, the graphics card 306 includes substantial dedicated graphical processing capabilities, so that the CPU 301 is not burdened with computationally intensive tasks for which it is not optimised. Graphics card 306 supplies graphical data to visual display unit 206. Similarly, a sound card 307 receives sound data from the CPU 301, along with sound processing instructions. Preferably, the sound card 307 includes substantial dedicated digital sound processing capabilities, so that the CPU 301 is not burdened with computationally intensive tasks for which it is not optimised.

An input/output interface 308 and a Universal Serial Bus (USB) interface 309 provide connectivity to peripherals such as a mouse 208 and keyboard 207 and said interfaces receive input commands from said keyboard 207 and mouse 208. A network card 310, a modem 311, the CD-ROM drive 202 and the external medium drive 204 are also connected to bus 302. The network card 310 provides connectivity to other user terminals present on the LAN and the modem 311 provides connectivity to the Internet 107 via a telephone connection to the user's ISP 104.

The equipment shown in FIG. 3 constitutes a personal computer of fairly standard type, such as an IBM PC compatible or Apple Macintosh, whether used as a network terminal 101, 102 or as a network server 103.

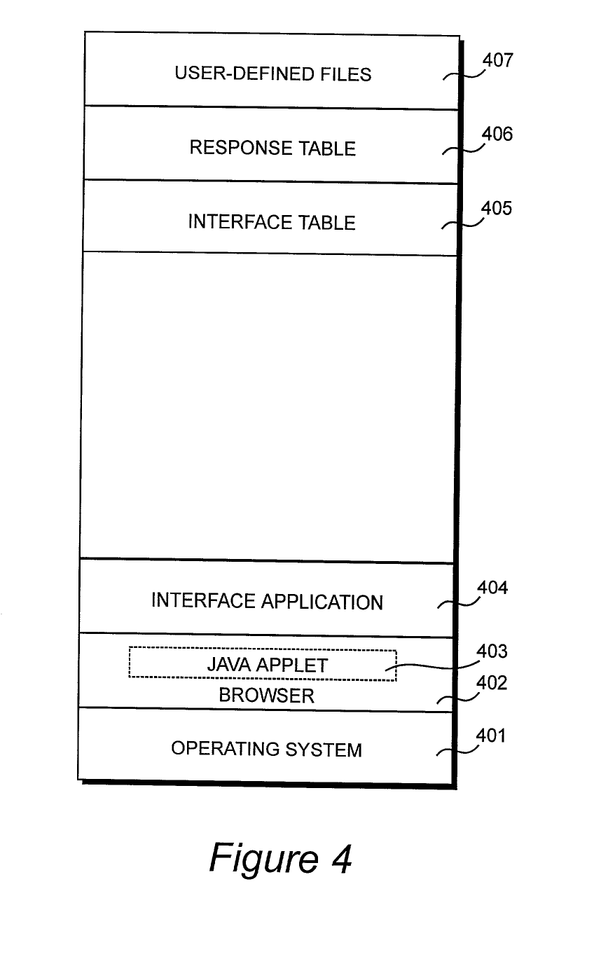

FIG. 4

The contents of the memory 302 of the computer system 201 detailed in FIG. 3 are summarised in FIG. 4.

An operating system, including a basic BIOS is shown at 401. Said operating system provides common functionality shared between all applications operating on the computer system 201, such as disk drive access, file browsing and handling and window-based graphical user interfacing. According to the invention, the operating system 401 can be any operating system including a BIOS and which is at least equipped with a file browser which supports applets, such as Java and/or DHTML applets. In the example, said operating system is Windows 2000™, as computer system 201 is regularly connected to the Internet 107 and said operating system is known to those skilled in the art as particularly suited for this purpose. In the case of an Apple Macintosh, however, said operating system would be preferably Mac O/S X™.

The browser 402 includes instructions for browsing Internet information, which is typically presented as pages formatted according to the Hyper Text Mark-up Language (HTML). Said pages potentially include embedded program instructions in Java or DHTML and a variety of other, Internet-specific programming languages and browser 402 traditionally includes corresponding programming languages components known to those skilled in the art as ‘applets’, the purpose of which is to enable CPU 301 to process said embedded program instructions when accessed. According to the known art, however, said components are optional and are not necessarily functional when computer system 201 browses information on the Internet 107. In the example, browser 402 includes a Java applet 403 which is functional. In an alternative embodiment of the present invention, browser 402 includes a DHTML applet 403 (not shown) which is functional.

An interface application is shown at 404 and represents the program instructions of the data inputting application according to the present invention. Said program instructions are preferably, but not necessarily, written in Javascript and are executable by CPU 301 by means of the Java component 403 within browser 402. Upon being processed by CPU 301, said interface application 404 further instantiates an interface table 405 and a response table 406 within memory 302, the respective details of which will be detailed further in the present embodiment.

The user-defined files 407 include instructions and initialisation data that are usually present but inactive on the user's graphical display.

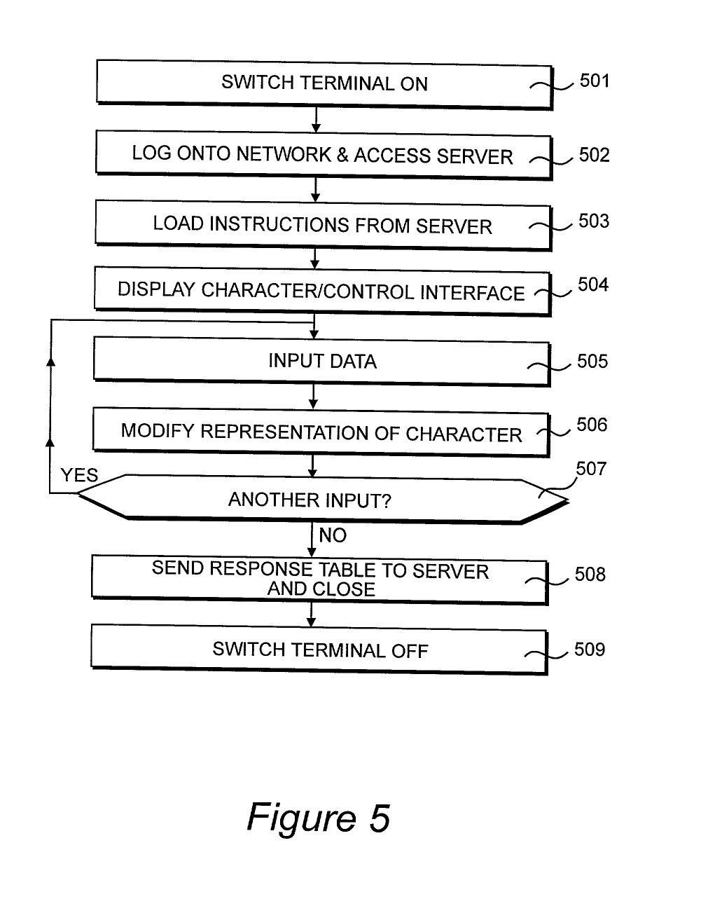

FIG. 5

Actions performed at a network-connected terminal, such as terminal 101, according to the invention are summarised in FIG. 5.

At step 501, user terminal 101 is switched on and loads the operating system 401, the browser 402 including the JAVA applet 403 from hard disk drive 305 into its main memory 302. At step 502, said user terminal 101 logs onto the Internet 107 by means of a modem connection 210 initialised between modem 311 and the user terminal's ISP 104. Upon being granted access to the Internet 107 by said ISP 104, user terminal 101 performs an information search and consultation by means of browser 402 and, within the course of said consultation, eventually accesses information stored in server 103.

At step 503, server 103 grants user terminal 101 access to its resources and, after the data sharing relationship is initialised, said server 103 uploads interface application 404 to user terminal 101, wherein said interface application 404 is downloaded into main memory 302. Upon completing the download of interface application 404, the JAVA applet 403 enables the CPU 301 to process the program instructions corresponding to interface application 404 and a graphical user interface of interface application 404 which contains adjustable and emotionally representative characters and modifiable graphical controls is displayed on the visual display unit 206 of user terminal 101 at step 504. At step 505, the user of user terminal 101 inputs data by means of interacting with said modifiable graphical controls and the graphical representation of said emotionally representative characters are adjusted correspondingly at step 506.

A question is asked at step 507 in order determine whether further input is required from the user of user terminal 101. If the question asked at step 507 is answered positively, control is then returned to step 505, wherein said user may again interact with said modifiable graphical controls. Alternatively, if the question of step 507 is answered in the negative, the data which was inputted at step 505 is sent to server 103 and, as the interface application 404 according to the invention is of no further use at this stage, said application is subsequently closed and removed from the main memory 302. User terminal 101 is eventually switched off at step 509 after the information search and perusing operations are deemed satisfactory by its user.

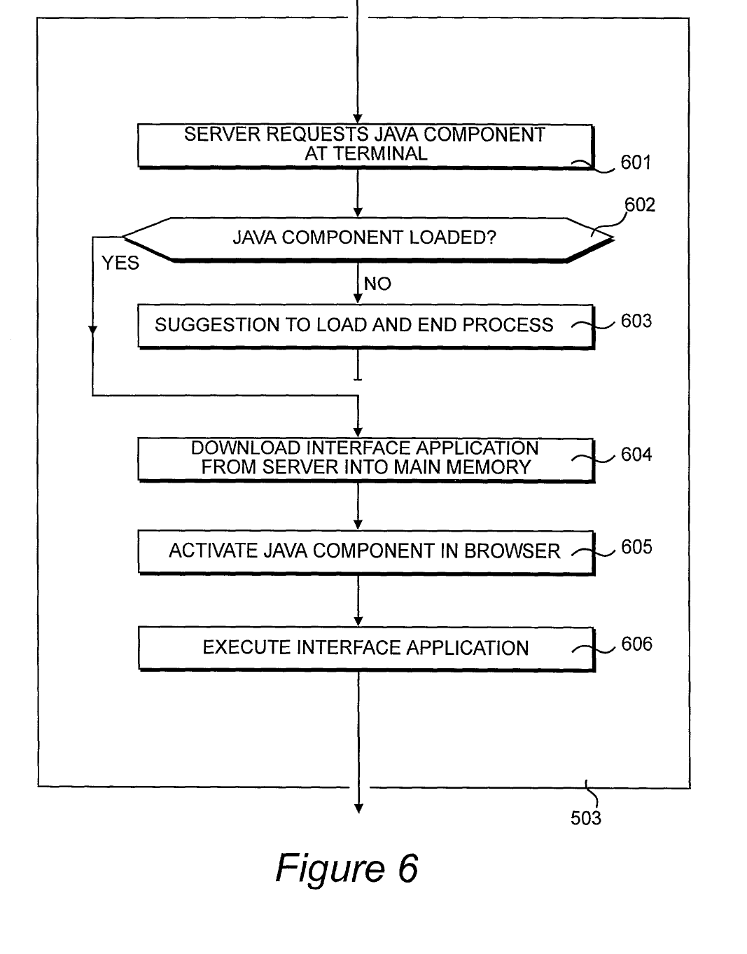

FIG. 6

Actions performed at terminal 101 in order to load interface application 404 from remote server 103 at step 503 and locally execute the program instructions are summarised in FIG. 6.

Prior to the upload of the interface application 404, server 103 initially determines whether user terminal 101 is suitably configured in order to process said application. Consequently, further to the access authentication and data sharing relationship carried out at step 502, server 103 polls browser 402 of user terminal 101 to check whether the JAVA applet 403 is present and functional at step 601. At step 602, a question is therefore asked in order to provide an answer to the request formulated by the server 103 at step 601. If the question asked at step 602 is answered negatively, then the JAVA applet 403 is either not installed or not functional or a combination thereof at user terminal 101. Server 103 subsequently forwards a suggestion to install the JAVA applet 403 and prevent the unnecessarily uploading of interface application 404 at step 603. Alternatively, if the question asked at step 602 is answered positively then the JAVA applet 403 is present and functional and user terminal 101 downloads said interface application 404 from server 103 into its main memory 302 at step 604. As the JAVA applet 403 was successfully poled and the download of step 604 is identified as program instructions written JAVA, the JAVA applet 403 is consequently activated within browser 402 at step 605.

Upon the totality of the program instructions corresponding to interface application 404 being downloaded and being now stored in main memory 302, the CPU 301 of user terminal 101 is thus now able to execute the interface application 404 at step 606.

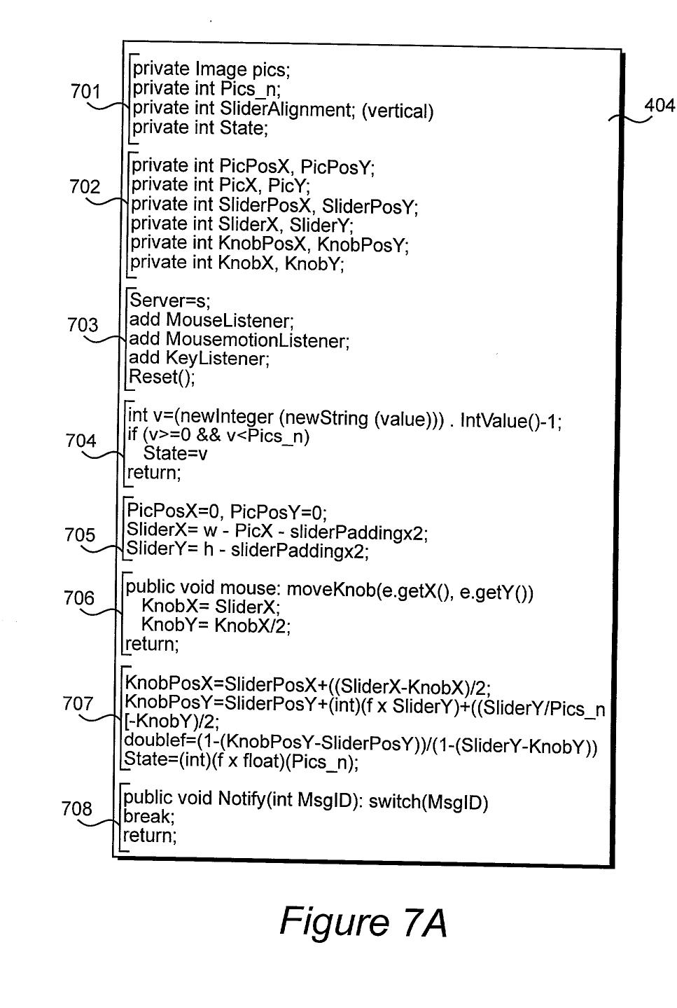

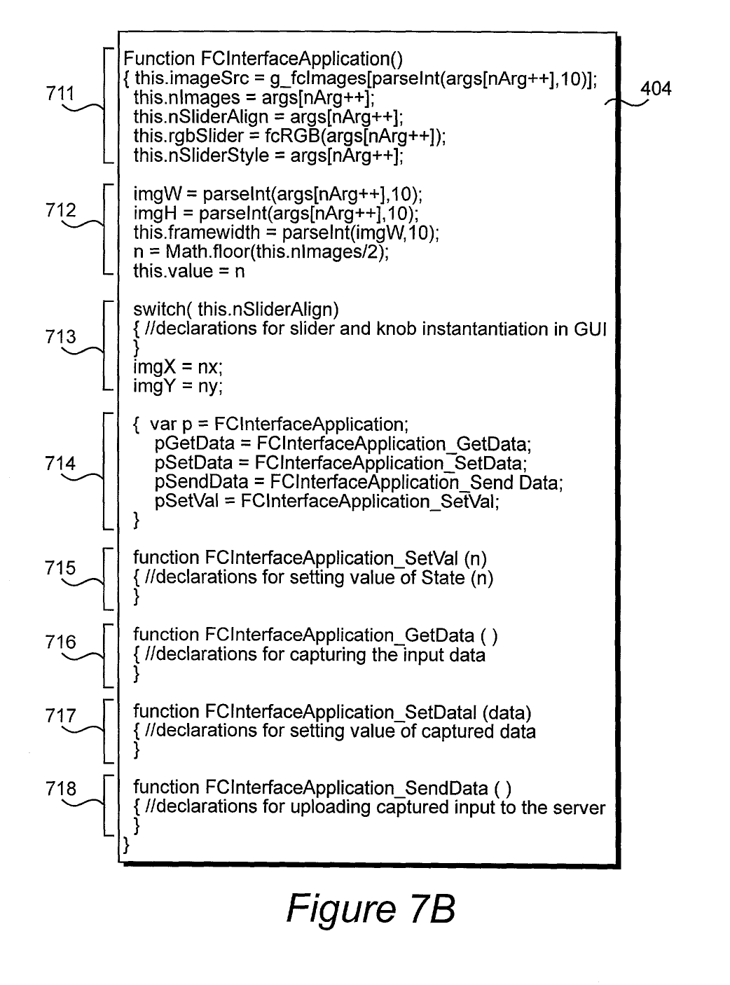

FIG. 7A

In an preferred embodiment of the present invention, the machine-readable instructions executed at step 608 in order to instantiate the adjustable and emotionally representative characters and modifiable graphical controls are shown in FIG. 7A as declared according to the Java programming language.

A source file is shown in FIG. 7A, which contains CPU instructions in ASCII characters, such as to be compiled by the JAVA applet 403 into binary code that can be processed by CPU 301. Accordingly, said source file enunciates a variety of declarations, the purpose of which is to instantiate the various data structures required by the interface application 404 and user specified variables and methods in order to confer the logic steps appropriate to the purpose of the interface application to said application.

According to the invention, the initial set of declarations 701 defines the main data structures of interface application 404, which will be instantiated within the interface table 405. In a sequential order, starting from the top, the first line of declarations 701 identifies a strip of graphical representations of an emotionally representative character, the second line identifies the number of said graphical representations in said strip, which is not limited but is representative of the range of non-qualifiable answers between two extremes, e.g. a bright sun to describe good weather, a black cloud with rain and lightning to describe bad weather and a complement of graphical representations depicting fair, moderately fair, etc. intermediate weather leaning towards both good and bad weather. The third line identifies a modifiable graphical control and its orientation when displayed and, finally, the fourth and last line defines the state of emotion corresponding to each separate graphical representation.

The next set of declarations 702 define the respective size and position attributes for each of the displayable data structures instantiated according to the initial set of declarations 701. The first two lines of declarations 702 identifies the position and size of said graphical representation, the next two lines identify the position and size of the modifiable graphical controls and the last two lines identify the position and size of the modifiable component of said modifiable graphical controls.

The third set of declarations 703 defines constants and methods with which to instantiate the default graphical user interface of interface application 404 and capture input data from the user. The first line within declarations 703 identifies the server to which input data will be sent, the next three lines instruct interface application 404 to capture input from keyboard 207 or mouse 208 and the last line instructs interface application 404 to reset the respective state of the emotionally representative character and the adjustable graphical controls to their default upon instantiating the application GUI.

The next set of declarations 704 enunciates an integer V, the value of which is assimilated as the state if said value is superior or equal to zero and inferior to the total number of graphical representations of the emotionally representative character.

The set of declarations 705 defines constraints according to which the various data structures will be positioned relative to one another within the GUI. The next set of declarations 706 defines a method according to which input data captured from keyboard 207 or mouse 208 is translated into two-dimensional Cartesian co-ordinates and the extent to which the translation defined by said Cartesian co-ordinates are applicable to the knob within the slider.

The penultimate set of declarations 707 enunciates the algorithm according to which the state of the emotionally representative character is derived from the aforementioned position of said knob within said slider, hence its specific representation from amongst the total number of representations instantiated according to declarations 701, and hence the input data from the user based upon the user's emotional response to the property said character relates to.

The final set of declarations 708 defines a method according to which the interface application 404 forwards the aforementioned states, which are temporarily stored in the response table 406, to server 103. Said instructions also instruct interface application 404 to close and erase itself upon completing said broadcast operation.

FIG. 7B

In an alternative embodiment of the present invention, the machine-readable instructions executed at step 608 in order to instantiate the adjustable and emotionally representative characters and modifiable graphical controls are shown in FIG. 7B as declared according to the DHTML programming language. The functionality of the declarations described herein is identical to the functionality of the declarations described in FIG. 7A, and the DHTML embodiment of the present invention shown in FIG. 7B is intended as simply representative of an alternative embodiment of the present invention.

A source file is shown in FIG. 7B, which contains CPU instructions in ASCII characters, such as to be compiled by the DHTML applet included as standard within browser 402 into binary code that can be processed by CPU 301. As described in FIG. 7A, said source file enunciates a variety of declarations, the purpose of which is to instantiate the various data structures required by the interface application 404 and user specified variables and methods in order to confer the logic steps appropriate to the purpose of the interface application to said application.

According to the invention, the initial set of declarations 711 defines the main data structures of interface application 404, which will be instantiated within the interface table 405. In a sequential order, starting from the top, the first line of declarations 711 identifies the interface application 404 as a function which includes a strip of graphical representations of an emotionally representative character declared at the second line. The third line identifies the number of said graphical representations in said strip, which is not limited but is representative of the range of non-qualifiable answers between two extremes, e.g. a bright sun to describe good weather, a black cloud with rain and lightning to describe bad weather and a complement of graphical representations depicting fair, moderately fair, etc. intermediate weather leaning towards both good and bad weather. The fourth line identifies a modifiable graphical control and its orientation when displayed, and the fifth and sixth lines both define the appearance of said modifiable graphical control.

The next set of declarations 712 defines the respective size and position attributes for each of the displayable data structures instantiated according to the initial set of declarations 711. The first two lines of declarations 712 identify the position of the emotionally representative character images. The third line identifies the position and size of the GUI and the last two lines identify an integer ‘n’, the value of which is assimilated as the state with which to relate captured data within the GUI with said emotionally representative character images.

The third set of declarations 713 defines constraints according to which the various data structures will be positioned relative to one another within the GUI. The first line within declarations 713 instructs the alignment of the knob and slider arrangement within the GUI of application 404 and declarations follow in order to specify the alignment of said arrangement within the GU and the manner with which input data should be related with the state ‘n’ in respect of said alignment.

The following set of declarations 714 defines functions, also known as methods, according to which the interface application 404 instantiates a default state (fifth line), captures input data from a user (second line), correlates said input data with said state ‘n’ in order to compute the corresponding integer (third line) and subsequently sends the captured input data representative of the emotional response of the user to the server 103 (fourth line).

The following sets of declarations 715, 716, 717 and 718 define the logic steps according to which the methods declared in set 714 operate. Accordingly, the set of declarations 715 defines the default state ‘n’ in terms of knob position within the slider and corresponding emotionally-representative character within the GUI of application 404.

The next set of declarations 716 defines the logic steps according to which interface application 404 captures input data from keyboard 207 or mouse 208 and translates said input data into two-dimensional Cartesian coordinates which define the extent to which the knob moves within the slider.

The penultimate set of declarations 717 enunciates the algorithm according to which the state of the emotionally representative character is derived from the aforementioned position of said knob within said slider, hence its specific representation from amongst the total number of representations instantiated according to declarations 711, and hence the input data from the user based upon the user's emotional response to the property said character relates to.

The final set of declarations 718 defines a method according to which the interface application 404 forwards the aforementioned states, which are temporarily stored in the response table 406, to server 103. Said instructions also instruct interface application 404 to close and erase itself upon completing said broadcast operation.

All of the above sets of declarations merely serve to illustrate the contents of the download accomplished at step 503 and it will be apparent to those skilled in the art that many different ways of programming the functionality described herein exist and can be accomplished in many different programming languages such as Java and DHTML in the example, but also C, C++, Flash, Shockwave and others, all of which are claimed by the present invention.

As the machine-readable instructions declared in declaration sets 701 to 708 or, alternatively, declaration sets 711 to 718 are processed by CPU 301 according to step 608, an interface table 405 and a response table 406 are instantiated within main memory 302, along with all of the data structures contained therein.

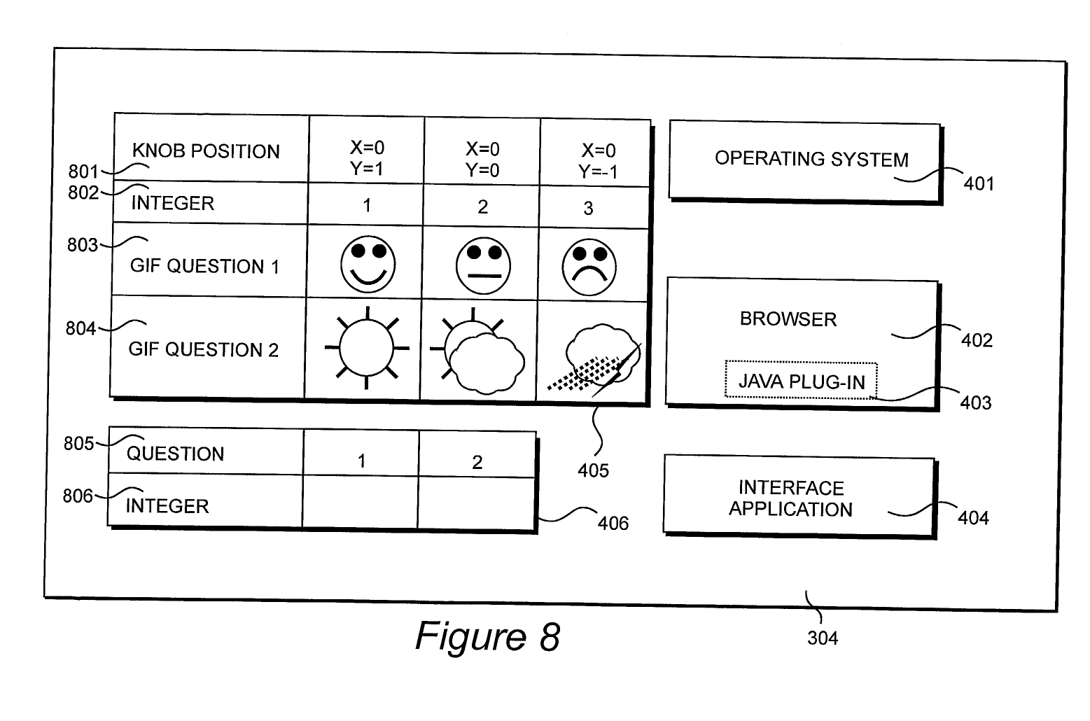

FIG. 8

The contents of the interface table 405 and the response table 406 instantiated in the memory 302 by the program instructions 701 to 704 are detailed in FIG. 8.

Main memory 302 is schematically represented and all of the data structures and applications previously detailed in FIG. 4 are shown therein. More particularly, the contents of interface table 405 instantiated according to the set of declarations 701 are further detailed. Said contents include positional choices 801 pertaining to the modifiable graphical control and corresponding integer values 802. In a further embodiment of the present invention, the integers 802 stored in response table 406 have text labels attached to them. In the example, integer 1 has a “Good” text label attached, whereas integer 2 has a “Fair” text label attached and integer 3 has a “Bad” text label attached.

Said contents further include a strip 803 of alternative graphical representations of an emotionally representative character corresponding to three alternative emotional states answering a first question and a strip 804 of three alternative graphical representations of an emotionally representative character corresponding to alternative emotional states answering a second question. It will be understood that either of the three alternative graphical representations contained in strips 803, 804 are for the purpose of illustration only and, as it was previously explained that the number of said graphical representations is not limited in the present invention, both the quantity and graphical depiction of said graphical representations can be liberally implemented to best reflect the non-quantitative answers sought from users.

The alternative positions 801 of the knob within the slider are given as two-dimensional Cartesian co-ordinates such that, upon being matched by the two-dimensional Cartesian co-ordinates read from the user input, said cartesian co-ordinates can be matched against their respective integer and graphical representation of the emotional representative character within integer values 802, strip 803 and strip 804.

The contents of the response table 406 instantiated according to the sets of declarations 701 and 703 are also further detailed. Set contents include question identifiers 805 implemented so as to ascertain for which particular question is input data generated for. Said contents also include answer fields 806 wherein integers 802 are written according to the positional information 801 read from the user input, such that answer fields 806 constitute a user's emotional response to each of the questions asked, quantified as an integer value.

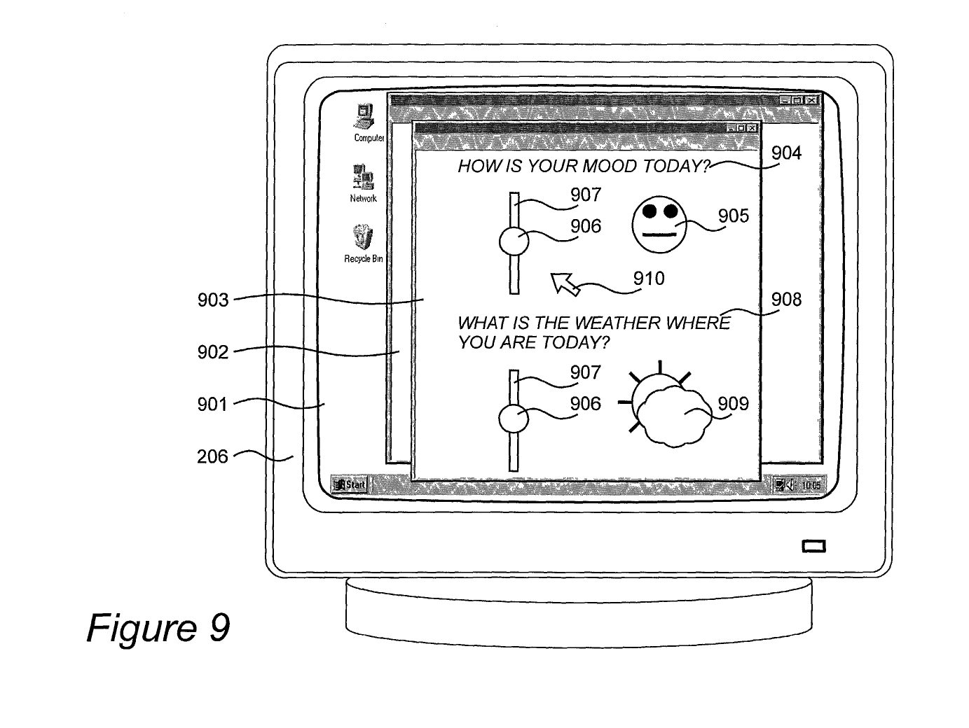

FIG. 9

A graphical representation of the Graphical User Interface (GUI) of the interface application 404 displayed at step 504 is shown in FIG. 9.

Upon completing the instantiation of the interface table 405 and the response table 406, and their respective data structure therein, interface application 404 generates a graphical user interface according to the sets of declarations at 701 through to 703. Accordingly, visual display unit 206 of user terminal 101 is shown as displaying the GUI 901 of the operating system 401 and, as said operating system is multitasking and provides functionality for multiple windows-based graphical user interfacing, the GUI 902 of browser 402 is overlaid onto said GUI 901. Likewise, the GUI 903 of interface application 404 is overlaid over both GUI 901 and GUI 902 when it is generated.

In the example, the user of server 103 is conducting a survey in order to determine a relationship between the well being of the respondents and the local weather at the time of answering said survey. Accordingly GUI 903 displays various data structures contained within interface table 405 and appropriate to collate input data about both topics. A first question 904 is displayed as ASCII characters, the answer to which is non-quantifiable by nature as said question asks respondents what their particular mood is. It was previously explained that the GUI is generated with default states and values and thus a neutral graphical representation 905 of an emotionally representative character contained within strip 803 is displayed in regard of the first question 904. Similarly, a knob 906 is displayed within a slider 907, the neutral, middle position of which suggesting that it can be adjusted upwards or downwards.

In keeping with the purpose of the survey, a second question 908 is displayed as ASCII characters and asks respondents what the state of the local weather is. According the same reasoning as detailed above, a neutral graphical representation 909 of an emotionally representative character relating to said question is displayed in regard of question 908. A second instantiation of knob 906 and a second instantiation of slider 907 are displayed in such a way as to suggest that said second instantiation of knob 906 can be adjusted upwards or downwards within said second instantiation of slider 907. Actions performed according to the processing of declaration sets 701 to 708 by CPU 301 ensure that input data generated by means of interaction between mouse pointer 910 and the first and second instantiations of knob 906 are accurately read in relation to the questions said instantiations respectively relate to. Input data embodying a respondent's emotional state as an answer to questions 904 and 908 can now be received and processed by interface application 404.

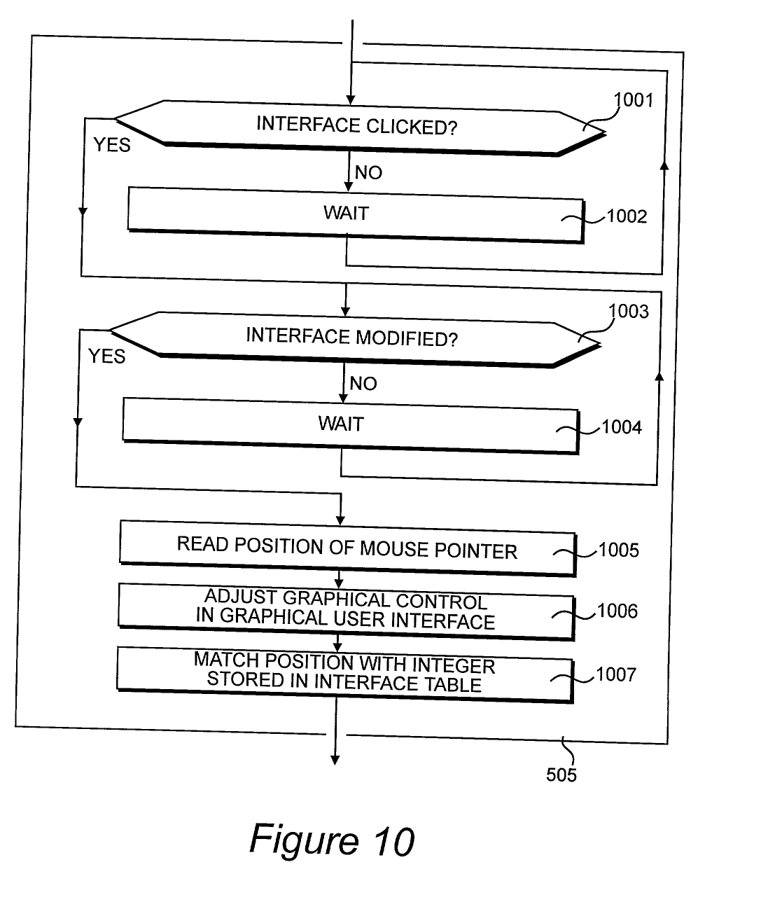

FIG. 10

Actions performed by the interface application 404 at step 505 in order to receive and process input data are summarised in FIG. 10.

A first question is asked at step 1001 in order to determine whether the interface, ie either of the first or second instantiations of knob 906 have been clicked via mouse pointer 910 by means of mouse 208, or alternatively, whether input is received from keyboard 207. If the question of step 1001 is answered negatively, then interface application 404 executes a wait instruction at step 1002, whereby control is returned to the question of step 1001 until such time as it is answered positively, wherein a second question is asked at step 1003. Said question asks whether the interface, ie either of the first or second instantiation of knob 906 has been modified, ie moved upwards or downwards in the example. If the question of step 1003 is answered negatively, then interface application 404 again executes a wait instruction at step 1004, whereby control is returned to question 1003.

Question 1003 is eventually answered positively, whereby either of the first or second instantiation of the knob 906 has been clicked and moved via the mouse pointer 910 by means of mouse 208, or by means of input from keyboard 207 and the corresponding input is read at step 1004 according to declarations set 703 to 705. At step 1005, the method defined by the declaration set 706 translates the two-dimensional Cartesian coordinates of the mouse pointer 910 read at step 1004 as a positional update of the knob 906 contained within the knob positional information 801 within interface table 405, whereby the position of the graphical control, ie knob 906, is adjusted within the GUI 903 of the interface application 404, at step 1006. At step 1007, said positional update of the knob 906 contained within the knob positional information 801 within interface table 405 is matched against the corresponding integer contained within the integer information 802.

According to the invention, as the position of the knob 906 is modified relative to the slider 907, the graphical representation of the emotionally representative character corresponding to said modified slider is similarly amended, such that the interactivity between said knob and said graphical representation apparent to the user, as well as the ease of use of the interface application according to the invention, effectively retain the intention of said user. Furthermore, empathy between said user and the emotionally representative character is conductive of a more accurate emotional response from said user to the question said emotionally representative character is related to.

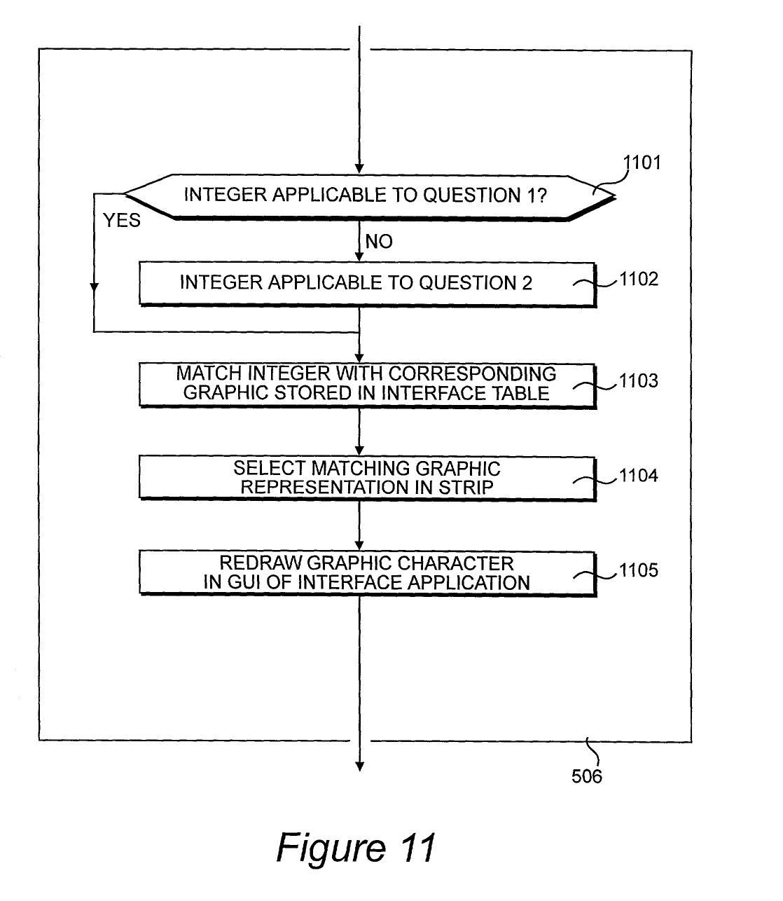

FIG. 11

Actions performed by the interface application 404 at step 506 in order to adjust the emotionally representative character 905 are summarised in FIG. 10.

A first question is asked at step 1101, in order to determine if the integer matched in interface table 405 at step 1007 is applicable to the first question 904. If the question asked at step 1101 is answered positively, control is then directed to step 1103 which will be further detailed in the present embodiment. Alternatively, if the question asked at step 1101 is answered in the negative, interface application 404 establishes that said matched integer is DE-FACTO applicable to the second question 908 at step 1102. Consequently, the integer 802 matched at step 1107 is further matched with the corresponding graphical representation of the emotionally representative character stored either in strip 803 or strip 804. Depending upon the question selection according to steps 1101 and 1102, at step 1103.

Interface application 404 subsequently selects the matched graphic representation of the emotionally representative character at step 1104 in order to redraw said graphic representation 905 or 909 within GUI 903 of said interface application 404.

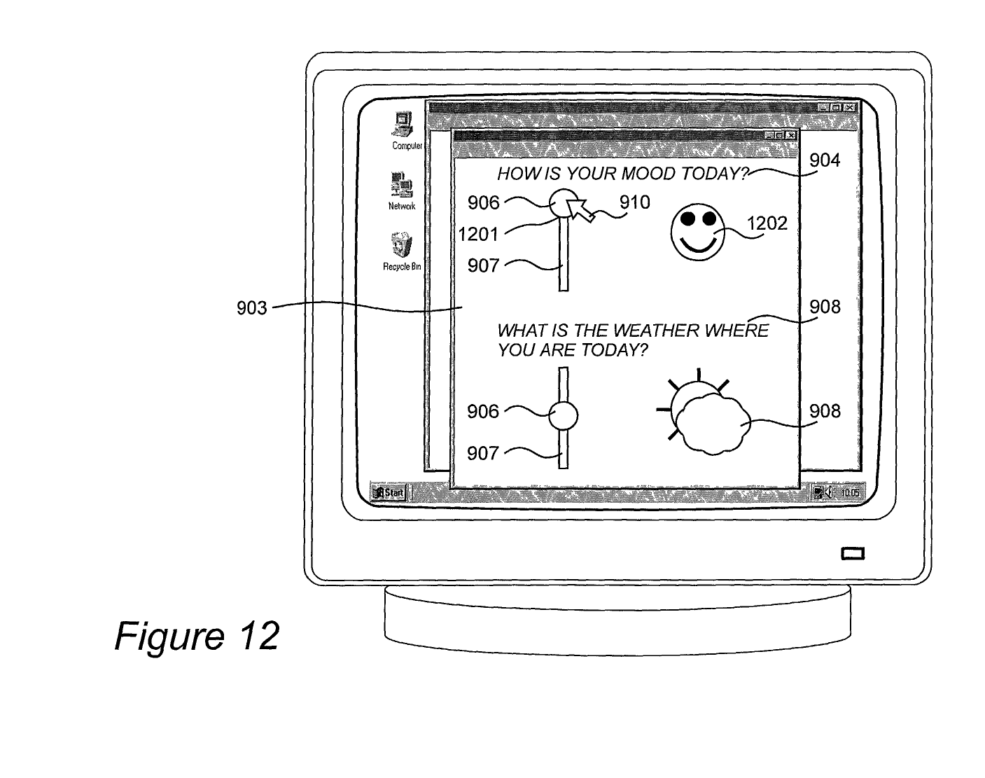

FIG. 12

The GUI 903 of the interface application 404 including the emotionally representative character 905 and its respective graphical control 906 modified according to steps 505 and 506 is shown in FIG. 12.

In the example, the user of user terminal 101 is in a good mood and thus interacts with data structures displayed within GUI 903 accordingly. The knob 906 is clicked via mouse pointer 910 by means of mouse 208 according to step 1001 and the user imparts mouse 208 with a forward movement, translated as an upward motion of mouse pointer 910 within GUI 903. The position of said mouse point 910 is read at step 1005 and, consequently, the knob 906 is adjusted relative to slider 907 to a new position 1201 which, in the two-dimensional Cartesian space defined by said slider 907 is matched as knob position information 801 (X=0, Y=1).

As the first instantiation of knob 906 was interacted with, question 1101 determines that the integer 802 subsequently matched as (1) according to step 1007 relates to question one and thus interface application 404 matches said integer 802 (1) with its corresponding graphical representation of the emotionally representative character within strip 803. Said graphical representation is a stylised smiling icon which is selected according to step 1104 and subsequently drawn as a new graphic representation 1202 within GUI 903 in replacement of the previous, default graphic representation 905, thereby translating the data input by the user of user terminal 101 with a character, the perceived emotional representation of which embodies said user's good mood in a satisfactory way.

The data structures 906, 907 and 909 relating to question 908 remain in their default state, as the user of user terminal 101 has not interacted with the second instantiation of knob 906 yet and thus another input is required according to step 507.

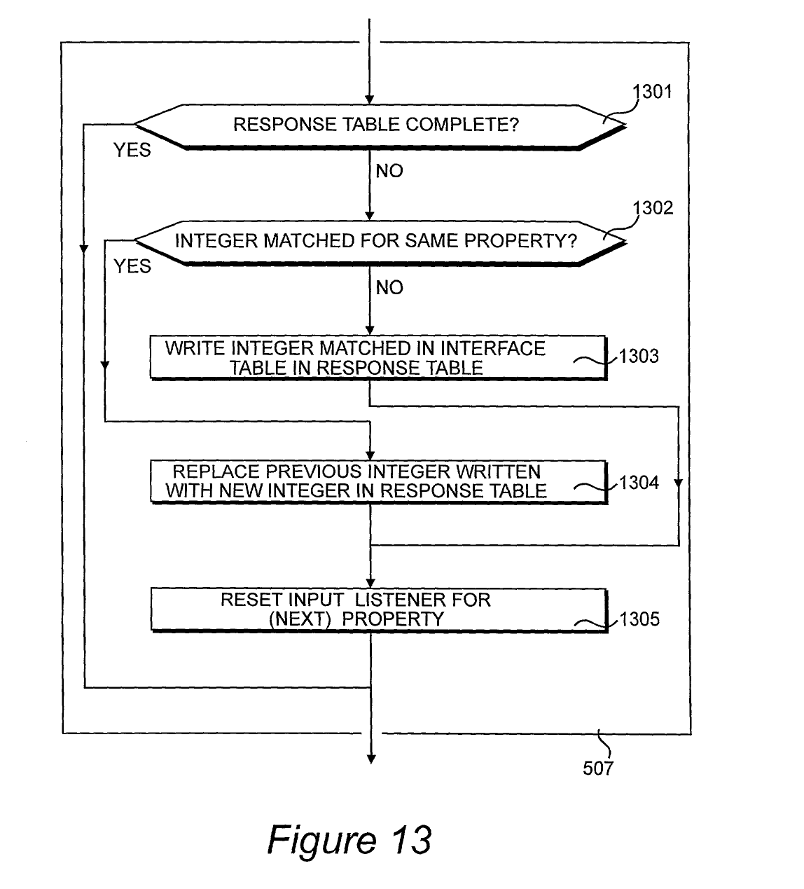

FIG. 13

Actions performed by the interface application 404 at step 507 in order to update the response table 406 are shown in FIG. 13.

Further to the graphical update conducted according to step 1105, interface application 404 asks a question at step 1301 in order to determine whether the answer fields 806 within response table 406 are populated. If the question of step 1301 is answered positively, then control is forwarded directly to step 508, which will be further detailed in the present embodiment. Alternatively, if the question asked at step 1301 is answered negatively, then a second question is asked at step 1302 in order to determine if the integer 1302 matched according to step 1007 has been matched for the same property, ie if the user of user terminal 101 has accomplished a second interaction with an instantiation of a knob 906 that has already been interacted with previously. If the question of step 1302 is answered negatively, then the integer 802 matched according to step 1007 is written in the answer field 806 within response table 406 corresponding to the question identifier 805 which itself is determined according to steps 1101 and 1002, at step 1303.

Alternatively, if the question asked at step 1302 is answered in the positive, then the previous integer written in said answer field 806 is replaced with the new integer at step 1304. At step 1305, the input listener defined by the declarations set 703 is reset in order to capture input data relating to the next property or question, whereby control is returned to step 505, ie step 1001.

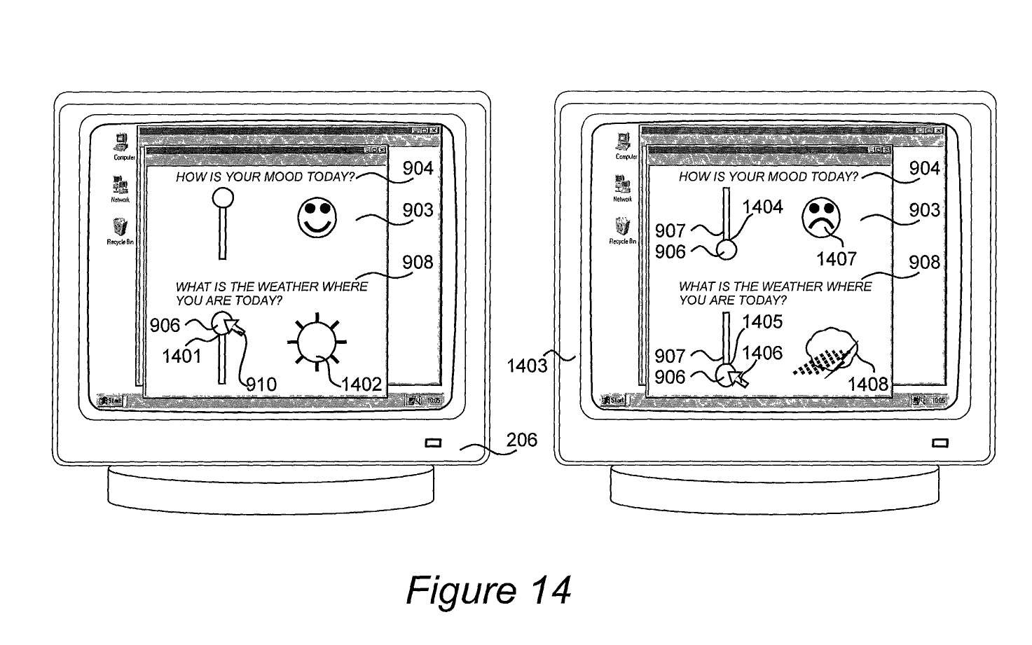

FIG. 14

The GUI 903 of the interface application 404, including both emotionally representative characters 905 and 909 and their respective graphical controls 906 and 907 modified according to steps 505 to 507, is shown in FIG. 14 at network-connected terminals 101 and 102 respectively.

In the example, the weather where user terminal 101 is physically located is sunny. Accordingly, the user of said user terminal 101 interacts with the second instantiation of knob 906 relating to the second question 908 in a similar fashion to the previous interaction relating to question 904. Said user therefore clicks onto said second instantiation of knob 906 via mouse pointer 910 by means of mouse 208 and imparts a forward movement, such that knob 906 is adjusted to a new position 1401 eventually resulting in the selection and display of the corresponding graphical representation 1402 within strip 804 in replacement of the default graphic representation 909.

In the example, the user of user terminal 102 also obtains access to server 103 and, following steps 501 through to 504, the visual display unit 1403 of user terminal 102 displays the same GUI 903 of interface application 404 downloaded from server 103, including identical questions 904, 908 and corresponding data structures instantiated within local interface table 405 and response table 406. As the interface application 404 at user terminal 102 is strictly identical to the interface application 404 described herein, the user of user terminal 102 interacts with GUI 903 in the same sequence of steps outlined above. However, in the example, said user of user terminal 102 is in a bad mood and the weather where user terminal 102 is physically located is stormy.

Accordingly, the user of user terminal 102 successively interacts with the first instantiation of knob 906 so that it is adjusted to position 1404 and the second instantiation of said knob 906 so that it is adjusted to position 1405, via mouse pointer 1406. In both instances, the matched integer 802 is “3” and the corresponding graphical representations within strips 803 and 804 respectively relating to questions 904, 908 are successively selected and respectively redrawn as graphical representations 1407 and 1408.

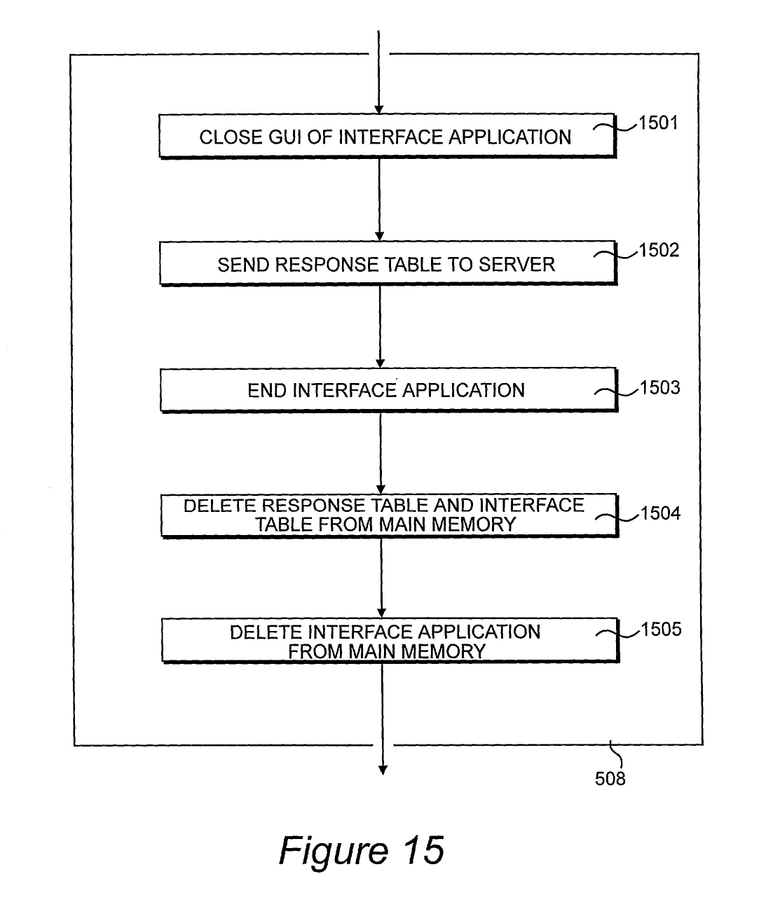

FIG. 15

Actions performed by the interface application 404 at step 508 in order to send the response table to the server 103 and end said application 402 are summarised in FIG. 15.

It was previously explained that the user of user terminal 101 has adjusted both instantiations of knob 906, thus both answer fields 806 now include an integer and the question asked at step 1301 is answered positively, signalling that no further input data is required from said user. Consequently, the interface application 404 closes its GUI 903 at step 1501, whereby it therefore stops being displayed on visual display unit 206. At step 1502, interface application 404 forwards the response table 406 to server 103 according to machine-readable instructions declared in declarations set 708. As the packet of data corresponding to said broadcast of said response table 406 is received at server 103, the interface application 404 at user terminal 101 is subsequently closed at step 1503, as it has no further purpose. Owing to the one time only utility of the survey embodied by questions 904 and 908, interface application 404 deletes the interface table 405, response table 406 and all of the data structures contained therein from main memory 302 at step 1504, before performing a self-erasing instruction at step 1505 in order to also delete itself from main memory 302.

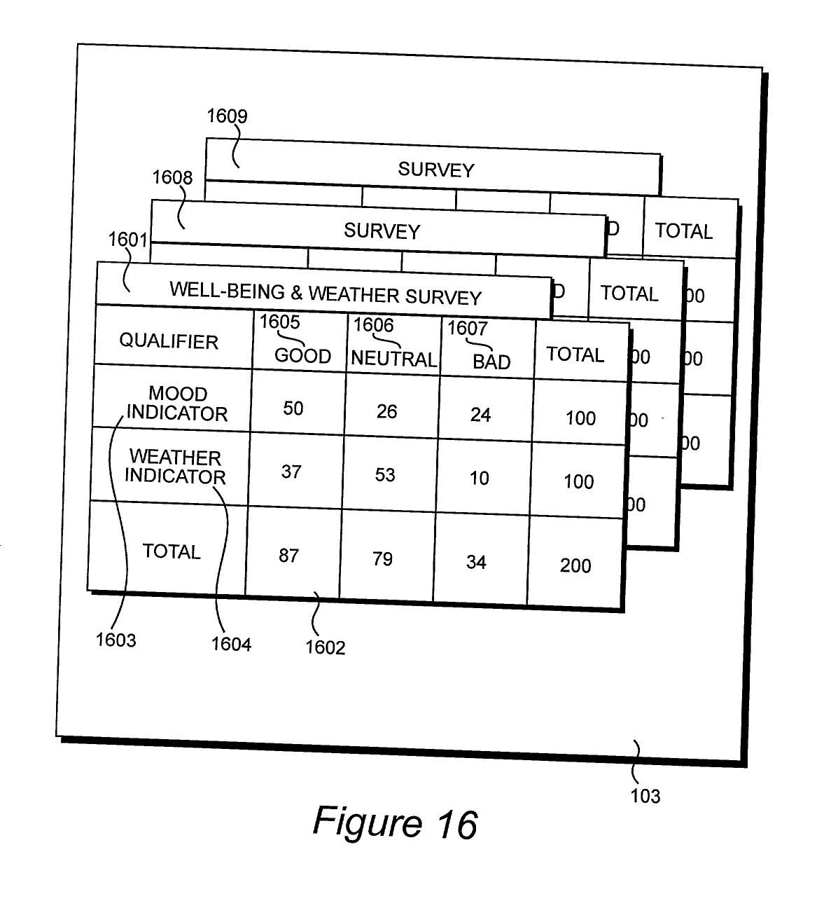

FIG. 16

Referring back to FIG. 5, user terminal 101 is eventually switched off at step 509. However, regardless of the timing of said switch off at step 509 at said user terminal 101, server 103 receives the packet of data corresponding to the response table 406, which contains the user's input data relating said user's emotional response to the questions 904, 908. Server 103 is thus configured to receive and store said input data in one or a plurality of databases for the purpose of compiling and analysing said data. A plurality of said input data-receiving databases stored at server 103 are shown in FIG. 16.

Database 1601 is configured to receive and store input data corresponding to the survey carried out at terminals 101 and 102, i.e. information about respondents' mood and local weather respectively sought according to questions 904 and 908. Input data is stored in data fields 1602, wherein each value is an integer. Upon server 103 receiving response tables 406, said integers are increased by a single unit depending upon the input data stored in said response tables.

In order to accurately accrue integers in data fields 1602, database 1601 includes a question qualifier 1603 pertaining to question 904 and a question qualifier 1604 pertaining to question 908. Therefore, when input data formatted according to response table 406 is received from network-connected user terminals, such as terminals 101 and 102, the question identifiers 805 are matched against the question qualifiers 1603, 1604 in order to accurately write said received input data in data fields 1602. Similarly, database 1601 includes an integer qualifier 1605 corresponding to integer “1”, an integer qualifier 1606 corresponding to integer “2” and an integer qualifier 1607 corresponding to integer “3”. Therefore, when input data formatted according to response table 406 is received from network-connected user terminals, such as terminals 101 and 102, the answer fields 806 are matched against the integer qualifiers 1605, 1606 and 1607 in order to accurately write said received input data in data fields 1602.

As more and more response tables 406 are received from user terminals accessing resources stored at server 103 and carrying out steps 503 to 508 according to the invention, the integers in data fields 1602 are dynamically updated. Input data which represents users' emotional response to questions inviting non-quantifiable answers is quantified and thus accrued, so as to obtain numerical data within which relationship patterns can be derived by means of further analysis. As the integers received within response tables 406 also have respective text labels attached to them, said relationship patterns derived by means of further analysis can be graphically presented in charts and tables within which the labels of the values are obtained from said attached labels, such that the readability of said graphical charts and tables is improved.

In a preferred embodiment of the present invention, server 103 stores a plurality of databases 1608 and 1609, the functionality of which is identical to database 1601. The input data respectively received and stored at databases 1608 and 1609 represents users' emotional response to questions different from questions 904 and 908 in the example, but nevertheless inviting non-quantifiable answers. The respectively interface applications 404 downloaded in order to receive said input data are thus configured according to the respective topics of databases 1608 and 1609 insofar as the graphical representations of questions 904 and 908, emotionally-representative characters 905 and 909, knob 906 and slider 907 are concerned, but their functionality remains identical.

In another preferred embodiment of the present invention, interface application 404 is configured not to self-delete from terminal 101's main memory, but to be stored in HDD 305 upon being initially downloaded and execute at regular intervals, for instance every time when a user logs onto the network, such that non-quantifiable data is input and subsequently sent to server 103 at said regular intervals. The benefit of said preferred embodiment is to receive non-quantifiable data representing input data from a user, based on said user's emotional response, about an identical qualitative question over a period of time, in order to further refine said relationship patterns derived by means of further analysis, as will be appreciated by those skilled in the art.

1. Apparatus for receiving input data from a user based on a user's emotional response to a property, including a plurality of network-connected user terminals, wherein each of said terminals includes memory means and processing means, said memory means is configured to receive instructions from one of said network-connected terminals and said instructions configure said processing means to perform the steps of:
(a) displaying a modifiable graphical control;
(b) displaying an adjustable, emotionally representative character;
(c) adjusting a representation of said character in response to the modification of said graphical control; and
(d) receiving input data in response to said modification of said graphical control.

2. Apparatus according to claim 1, wherein said instructions are received from said one of said network terminals by means of a downloading operation.

3. Apparatus according to claims I and 2, wherein said instructions are written in one or a plurality of higher-level and/or lower-level programming languages such as preferably, but nor exclusively, Java, Javascript, Dynamic Hypertext Mark up Language, C, C++, Flash, Shockwave and Assembler.

4. Apparatus according to claims I to 3, wherein said instructions configure said processing means to perform said steps preferably, but not necessarily, by means of applets.

5. Apparatus according to claim 1, wherein said modifiable graphical control includes preferably a knob configured to slide within a slider by means of user input.

6. Apparatus according to claim 1, wherein said adjustable, emotionally representative character is graphically represented in relation to the said property so as to generate said user's emotional response by inducing empathy from said user.

7. Apparatus according to claims 1 and 6, wherein said representation is adjusted from amongst a plurality of representations of said adjustable, emotionally representative character, which is representative of the range of emotional responses from the user to said property.

8. Apparatus according to claim 7, wherein said plurality of representations of said adjustable, emotionally representative character is not limited.

9. Apparatus according to claim 1, wherein said received input data includes one or a plurality of integers.

10. Apparatus according to claim 9, wherein said one or a plurality of integers further include labels, which are preferably, but not exclusively, text labels containing a string of ASCII characters.

11. A method of receiving input data from a user based on a user's emotional response to a property, comprising the steps of:
(a) displaying a modifiable graphical control;
(b) displaying an adjustable, emotionally representative character;
(c) adjusting a representation of said character in response to the modification of said graphical control; and
(d) receiving input data in response to said modification of said graphical control.

12. Method according to claim 11, wherein said instructions are received from said one of said network terminals by means of a downloading operation.

13. Method according to claims 11 and 12, wherein said instructions are written in one or a plurality of higher-level and/or lower-level programming languages such as preferably, but nor exclusively, Java, Javascript, Dynamic Hypertext Mark up Language, C, C++, Flash, Shockwave and Assembler.

14. Method according to claims 11 to 13, wherein said instructions configure said processing means to perform said steps preferably, but not necessarily, by means of applets.

15. Method according to claim 11, wherein said modifiable graphical control includes preferably a knob configured to slide within a slider by means of user input.

16. Method according to claim 11, wherein said adjustable, emotionally representative character is graphically represented in relation to the said property so as to generate said user's emotional response by inducing empathy from said user.

17. Method according to claims 11 and 16, wherein said representation is adjusted from amongst a plurality of representations of said adjustable, emotionally representative character, which is representative of the range of emotional responses from the user to said property.

18. Method according to claim 17, wherein said plurality of representations of said adjustable, emotionally representative character is not limited.

19. Method according to claim 11, wherein said received input data includes one or a plurality of integers.

20. Method according to claims 11 and 19, wherein said one or a plurality of integers further include labels, which are preferably, but not exclusively, text labels containing a string of ASCII characters.

21. A computer-readable memory system having computer-readable data stored therein, comprising
an operating system;
a browser including one or a plurality of applets;
program instructions;
one or a plurality of interface tables;
one or a plurality of response tables;

22. A computer-readable memory system according to claim 21, wherein said program instructions are configured to:
(a) displaying a modifiable graphical control;
(b) displaying an adjustable, emotionally representative character;
(c) adjusting a representation of said character in response to the modification of said graphical control; and
(d) receiving input data in response to said modification of said graphical control.
